(19) United States
(12) Patent Application Publication
(10) Pub. No.: US 2022/0090925 A1
(43) Pub. Date: Mar. 24, 2022

(54) Transportation Dating System and Method

(71) Applicant: Cole Patrick Thompson, Los Angeles, CA (US)

(72) Inventor: Cole Patrick Thompson, Los Angeles, CA (US)

(73) Assignee: Gentleman LLC, City of Lewes, DE (US)

(21) Appl. No.: 17/026,579

(22) Filed: Sep. 21, 2020

(51) Int. Cl. G01C 21/34; G01C 21/36; G06Q 10/02; G06Q 50/00; G06Q 50/30; H04W 4/02

(52) U.S. Cl. CPC G01C 21/3438; G01C 21/3617; H04W 4/023; G06Q 50/01; G06Q 50/30; G06Q 10/02

(57) ABSTRACT

A transportation dating system and method is provided. The system may enable a primary rider to invite secondary riders to share a ride from a first location to a second location within a window of time. The system also may enable secondary riders to request to ride with a primary rider from a first location to a second location within a window of time. In this way, primary riders and secondary riders may meet and spend time with each other during time otherwise spent idle and/or alone.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

This invention relates to a framework, system, and method of transportation, including a transportation system that facilitates the matching of transportation participants to share a transportation experience.

### BACKGROUND

Ground transportation systems such as ridesharing services, taxi services, and bus ride services are common throughout the world. In use, a person wishing to travel locally from one location to another may simply use a mobile application to arrange a rideshare, call a taxi, or use the local bussing system.

However, when in use, the traveler typically sits idle, often by themselves, during the journey. And this is time that could also be spent doing other things, such as meeting with and getting to know other local travelers.

In addition, traveling with only one person in each vehicle increases the carbon footprint of the transportation system, while requiring the solo traveler to pay the full fare themselves.

It is true that some ground transportation services allow travelers to share a ride. However, the systems pair the travelers strictly by determining if the travelers' routes align, and the travelers themselves have absolutely no say or choice with who he/she may be paired with. This is a challenge of the current transportation systems and often leads to persons being paired with others that they do not feel comfortable with and/or even unsafe. For example, some travelers may be intoxicated and may act in a way that makes the other travelers uncomfortable. Other travelers may be outspoken regarding cultural issues and may make the trip awkward or even unbearable to riders with differing views. Other travelers may attempt to solicit fellow riders with romantic and/or sexual innuendos, thereby making the riders feel unsafe.

Accordingly, there is a need for a system that provides transportation services while matching riders to meet one another and potentially enter into a mutually agreed upon relationship. There also is a need for a system that facilitates people to carpool, thereby reducing the carbon footprint as well as the cost to each traveler.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification. None of the drawings are to scale unless specifically stated otherwise.

FIG. 1 shows an overview of a transportation dating framework in accordance with exemplary embodiments hereof;

FIG. 2 shows steps taken when using a transportation dating system in accordance with exemplary embodiments hereof;

FIG. 3 shows steps taken when using a transportation dating system in accordance with exemplary embodiments hereof;

FIG. 4 shows aspects of a transportation dating system in accordance with exemplary embodiments hereof; and

FIG. 5 depicts aspects of computing and computer devices in accordance with exemplary embodiments hereof.

### DETAILED DESCRIPTION OF EXEMPLARY EMBODIMENTS

As used herein, unless used otherwise, the following terms and abbreviations have the following meanings:

As is known in the art, ridesharing means to participate in an arrangement in which a passenger travels in a private vehicle driven by its owner, for free or for a fee, especially as arranged by means of a website or mobile application (“mobile app”).

The term primary rider PR will refer to a user of the system 10 who may request a ride from a starting location to a destination location and who may invite and/or accept requests from secondary riders SR to accompany them during at least a portion of the ride. The primary rider PR may have any gender identity with any sexual preference.

The term secondary rider SR will refer to a user of the system 10 that requests and/or is invited to accompany the primary rider PR during at least a portion of the primary rider's ride. The secondary rider SR may have any gender identity with any sexual preference.

In general, the system according to exemplary embodiments hereof provides transport services such as the scheduling of transportation (e.g., ridesharing services, taxi services, etc.), the determining of the necessary routing of the vehicles used for the transportation, the implementation of the transportation, and other services. In addition, the system and method enables participants to share transportation services (such as ridesharing) and experiences as a way to meet and to get to know new people. In some embodiments, a primary rider PR may schedule a ride and the system may facilitate the matching of secondary riders SR to share the ride with the primary rider PR. In this way, the primary rider PR and the secondary rider SR may spend time together during the ride, and if the riders PR, SR feel a connection, they may continue exploring the new relationship. If either of the riders PR, SR do not wish to explore the new relationship, the meeting ends once the transportation destination is reached.

The system may facilitate the matching of primary riders PR and secondary riders SR in a variety of ways as will be described herein. As an incentive for primary riders PR to allow secondary riders SR to join them for the ride, the system may require the secondary riders SR to pay for at least a portion (and preferably for all of) the transportation cost. However, this may not be required.

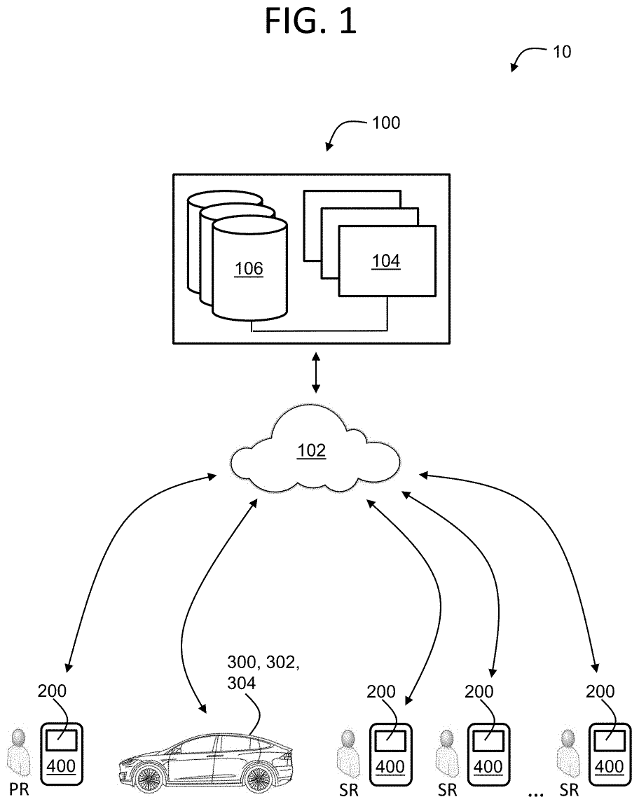

FIG. 1 shows an overview of an exemplary framework for a transportation dating system 10 (also referred to as a transportation system 10 or simply as a system 10) according to exemplary embodiments hereof. As shown, the transportation dating system 10 may include a backend system 100 that may interface with an application 200 (e.g., a mobile application or “app”, a website viewed using a browser, or other types of applications) and a transportation system 300. The interface may include a network 102 (e.g., the Internet, LAN, WAN, etc.), wireless communication systems, cellular communication systems, telephony or other types of communication systems or protocols.

The system 10 may be accessed by multiple users (e.g., primary riders PR and/or secondary riders SR) via the network 102 and using the mobile application 200 running on one or more computing devices 400 (e.g., smart phones, tablet computers, laptops, desktop computers, mobile media players, etc.).

In some embodiments, the backend system 100 may include a cloud platform (e.g., one or more backend servers), one or more local controllers, or any combination thereof. In some embodiments, the backend system 100 includes a cloud platform that interfaces with one or more local controllers. For example, administrators of the system 10 may interface with the system 10 via a local controller in communication with a cloud platform.

The backend system 100 may include a plurality of applications 104 and databases 106 as will be described in other sections.

In some embodiments, the transportation system 300 incudes a ridesharing system 302. The ridesharing system 302 enables a person to schedule and be provided with a ride from a first location to a second location. The scheduling of the ride may be made in advance (e.g., 48 hours prior to the pickup) or in real time (or near real time).

For example, a primary rider PR may use the application 200 to schedule a pickup at a particular location at a particular time to be taken to a particular destination. For instance, the primary rider PR may schedule a pickup time for the next morning at 10:00 am to be taken to an appointment. In another example, a primary rider PR may require a near real time pickup time (e.g., in the next 15 minutes). In this example, a primary rider PR may use the application 200 to request a ride, and the system 10 may determine the current location of the rider PR (e.g., using GPS) and the nearest available driver to perform the pickup and overall ride service. Once a driver is selected, the application 200 may provide the rider PR with the driver's name, type of car, license plate number, and route (preferably via a dynamic map). In this way, the rider PR is able to track the driver's location, as well as receive a text message from the driver once they arrive for the pickup.

For the purposes of this specification, it is understood that the ridesharing system 302 may include any services, functionalities, elements, characteristics, and structure of any ride sharing services as known in the art. In some embodiments, the ridesharing system 302 is integrated into the system 10 while in other embodiments the ridesharing system 302 is provided by a third-party service. In some embodiments, portions of the ridesharing system 302 are integrated into the system 10 while other portions of the ridesharing system 302 are provided by a third-party ridesharing provider.

In other embodiments, the transportation system 300 includes a taxi service system 304. For the purposes of this specification, it is understood that the taxi service system 304 may include any services, functionalities, elements, characteristics, and structure of any taxi service systems as known in the art. In some embodiments, the taxi service system 304 is integrated into the system 10 while in other embodiments the taxi service system 304 is provided by a third-party service. In some embodiments, portions of the taxi service system 304 are integrated into the system 10 while other portions of the taxi service system 304 are provided by a third-party ridesharing provider.

Other types of transportation systems such as bus services, subway services, train services and other types of transportation services also may be used. It is understood by a person of ordinary skill in the art that the transportation system 300 may include any types and/or combinations of types of transportation systems that may provide a traveler transportation for any type of trip, and that the scope of the system 10 is not limited in any way by the types of transportation systems utilized by the system 10 nor the types of trips that the system 10 may provide.

It also is understood that while this specification may describe the system 10 primarily as providing a ridesharing service 302, all of the details described herein also may be applied to the system 10 while providing any other type of transportation system 300.

Users who may wish to use the system 10 (e.g., potential primary riders PR and/or potential secondary riders SR) may be required to register with the system 10 and to provide profile information to be stored in the backend system 100. For example, each potential user PR, SR may provide his/her first name, a photograph of themselves, personal interests, career interests, gender identity, sexual preferences, age, height, weight, hair color, eye color, any other types of information and any combination thereof. As will be described in other sections, this profile information may be used during the system processes to match primary riders PR with secondary riders SR, and vise versa, to share in ridesharing experiences. It is understood that the system 10 may protect all supplied data using industry privacy standards such that all participants and the data they may provide are kept safe and protected.

In use, potential primary riders PR may use the system 10 to identify potential secondary riders SR to share in a ridesharing experience, and potential secondary riders SR may use the system 10 to find potential primary riders PR with whom they may wish to join for a ride.

Additional embodiments and details of the system 10 will be described by way of several detailed use scenarios. The use scenarios provided below are chosen to illustrate various embodiments and implementations of the system 10, and those of ordinary skill in the art will appreciate and understand, upon reading this description, that the examples are not limiting and that the system 10 may be used in different ways. It also is understood that details and elements of different embodiments described in different scenarios and examples may be combined in any way to form additional embodiments that are all within the scope of the system 10.

Scenario #1:

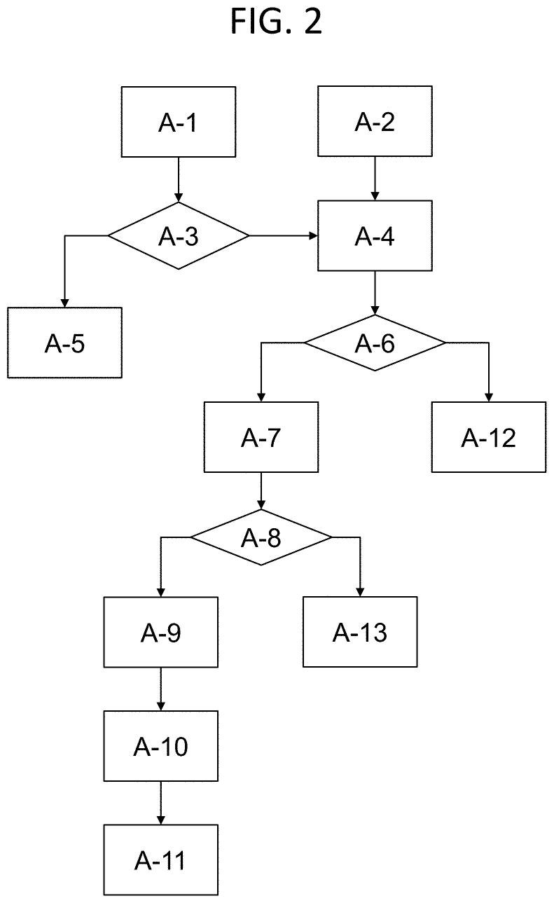

In some embodiments, the primary rider PR may invite one or more secondary riders SR to join him/her during his/her ridesharing experience. As shown in FIG. 2, the general acts taken by the primary rider PR, the secondary rider SR and/or the system 10 in this scenario may include the following (without limitation):
A-1 One or more potential secondary riders SR may open the mobile application 200 running on his/her mobile device 400 and identify themselves as interested and available to accompany a primary rider PR during a ride. In some embodiments, the system 10 determines if the secondary riders SR each meet a certain ride criteria (also referred to as ride candidate criteria). For example, the system 10 may determine the location of each respective secondary rider SR (e.g., using GPS or other locator) and compare his/her location to the starting location, the destination location, and/or to each point along a route between the starting location and the destination location to determine if the secondary rider's location is within a distance threshold of any of these points. If so, the secondary rider SR may meet the ride candidate criteria. If not, the secondary rider SR may not meet the ride candidate criteria. Note that the determined distance may include the ground distance. In another example, the system 10 may use the information provided by the secondary rider SR in his/her profile information to determine if the secondary rider SR meets other types of ride criteria such as gender, age, sexual preferences and other types of criteria. Ride candidate criteria may include, without limitation, (i) rides within a particular radius of or a particular distance from a particular location (e.g., within a 5 mile radius of the secondary rider's current location), (ii) rides from a particular pickup location and/or to a particular destination location, (iii) rides during a particular window of time on a particular day (e.g., in one hour from the current time), (iv) gender identity and/or sexual preferences, and (v) other types of ride criteria. The ride criteria for each potential secondary rider SR may be (I) set during the registration process, and/or (ii) dynamically entered, uploaded, and stored on the backend system 100 during each interaction with the system 10, set by an administrator of the system 10, set by other persons or methods, or any combination thereof.
A-2 A primary rider PR may open the mobile application 200 running on his/her mobile device 300 and schedule a ride from a starting location to a destination location for a particular time and date. The ride information is uploaded and stored to the backend system 100. The primary rider PR also may choose ride criteria to be used by the system 10 while matching potential secondary riders SR for the scheduled ride. In some embodiments, default rider criteria may be provided by the system 10. Ride criteria may include, without limitation, (i) secondary riders SR within a particular radius of or a distance from a particular location (e.g., within a 5 mile radius of the primary rider's current location), (ii) gender identity and/or sexual preferences, and (iii) other types of ride criteria. The ride criteria for the primary rider PR may be (I) set during the registration process, and/or (ii) dynamically entered, uploaded, and stored on the backend system 100 during each interaction with the system 10, set by an administrator of the system 10, set by other persons or methods, or any combination thereof.
A-3 If a secondary rider SR meets the ride candidate criteria with relation to the primary rider's scheduled ride (and/or the ride criteria meets the ride criteria as declared by one or more potential secondary riders SR), the respective secondary riders' information (e.g., profile information including a profile picture, location information, etc.) may be made available to the primary rider PR through the app 200 for review at A-4.
A-5 If the secondary rider SR does not meet rider criteria (and/or the primary rider's ride does not meet the rider criteria for the secondary rider SR), the secondary rider SR may wait for the next primary rider PR posting.
A-6 The primary rider PR may choose one or more potential secondary riders SR.
A-7 If a secondary rider SR is chosen, the system 10 may send each chosen secondary rider SR a ridesharing invitation. The system 10 also may send the primary rider's profile information to each chosen potential secondary rider SR along with the invitation.
A-8 The one or more invited potential secondary riders SR may accept or decline the one or more invitations, and the corresponding primary rider PR may be notified accordingly.
A-9 If a potential secondary rider SR accepts a rideshare invitation, the system 10 may confirm the match with the primary rider PR and the secondary rider SR, and the transportation system 10 may determine the route between the first location and the secondary rider's location, and between the secondary rider's location and the destination location. In this way, an overall route for the transportation vehicle is determined that includes picking up the primary rider PR, picking up the secondary rider SR, and transporting both riders PR, SR to the destination location. The system 10 may then transmit information regarding the route to the transportation vehicle (e.g., to a user device associated with the rideshare vehicle), and the vehicle may pick up the primary rider PR and/or the secondary rider SR at their respective locations and subsequently follow the route.
A-10 The primary and secondary riders PR, SR may then spend time together during the ride.
A-11 Once the ridesharing service arrives at the destination location, the primary rider PR may exit the vehicle, and the secondary rider SR may choose to (i) also exit the vehicle, (ii) continue to a different location, or (iii) return to his/her original location. Note that the primary rider PR is not obligated to exit the vehicle if he/she may wish to continue spending time with the secondary rider SR.
A-12 If, at A-6, the primary rider PR does not choose to send any invitations to any secondary riders SR, the primary rider PR may choose (i) to ride alone, (ii) to reschedule the ride for another time, (iii) to reschedule the ride to a different destination location, (iv) to cancel the scheduled ride, or (v) to take other actions and any combination thereof.
A-13 If, at A-8, no secondary riders SR accept any invitations sent to them by the primary rider PR, the primary rider PR may choose (I) to ride alone, (ii) to reschedule the ride for another time, (iii) to reschedule the ride to a different destination location, (iv) to cancel the scheduled ride, or (v) to take other actions and/or any combinations thereof.

It is understood that the summary of steps described above is meant for demonstration and that the actual process may include additional steps not listed and/or less steps than listed. It is also understood that any of the steps may be performed in any different order.

Scenario #2

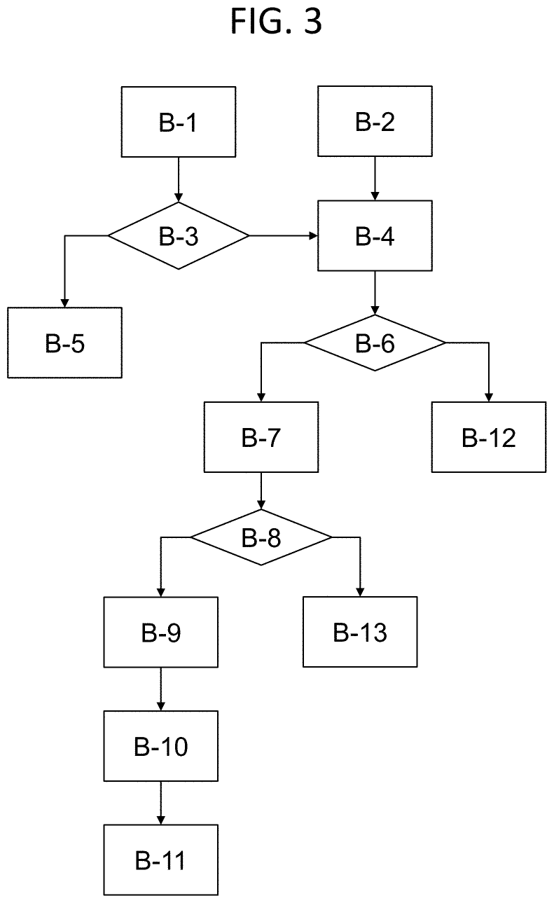

In some embodiments, a potential secondary rider SR may submit a request to join a particular primary rider PR during the primary rider's ridesharing experience. As shown in FIG. 3, the general steps taken by the primary rider PR, the secondary rider SR and/or the system 10 in this scenario may include the following (without limitation):
B-1 The primary rider PR may open the mobile application 200 running on his/her mobile device 400 and schedule a ride from a starting location to a destination location for a particular time and date. The ride information is uploaded and stored to the system backend 100. The primary rider PR also may choose ride criteria to be used by the system 10 while matching potential secondary riders SR for the scheduled ride. In some embodiments, default ride criteria may be provided by the system 10. Ride criteria may include, without limitation, (i) secondary riders SR within a particular radius of a particular location (e.g., within a 5 mile radius of the primary rider's current location), (ii) gender identity and/or sexual preferences, and (iii) other types of ride criteria. The ride criteria for the primary rider PR may be (i) set during the registration process, and/or (ii) dynamically entered, uploaded, and stored on the backend system 100 during each interaction with the system 10, or any combination thereof.
B-2 One or more potential secondary riders SR may open the mobile application 200 running on his/her mobile device 400 and identify themselves as interested and available to accompany a primary rider PR during a ride that meets certain ride criteria. In some embodiments, default ride criteria may be provided by the system 10. Ride criteria may include, without limitation, (i) rides within a particular radius of or distance from a particular location (e.g., within a 5 mile radius of the secondary rider's current location), (ii) rides during a particular window of time on a particular day (e.g., in one hour from the current time), (iii) gender identity and/or sexual preferences, and (iv) other types of ride criteria. The ride criteria for each potential secondary rider SR may be (i) set during the registration process, and/or (ii) dynamically entered, uploaded, and stored on the backend system 100 during each interaction with the system 10, or any combination thereof.
B-3 If the primary rider's scheduled ride meets the ride criteria as declared by one or more potential secondary riders SR, and/or vice versa, the primary riders' information (e.g., profile information, etc.) and the ride information (starting location, destination location, time of ride, etc.) may be made available to each respective secondary rider SR through the app 200 for review at B-4.
B-5 If the primary rider's scheduled ride does not match a secondary rider's ride criteria, the secondary rider SR may wait for the next primary rider PR posting.
B-6 Upon reviewing the ride and primary rider PR information, if a potential secondary rider SR is interested in accompanying the primary rider PR, he/she may submit a rideshare request.
B-7 Each rideshare request, including profile information of each respective requesting secondary rider SR, may be forwarded to the primary rider PR for review.
B-8 The primary rider PR may accept or decline one or more ride requests, and the corresponding potential secondary riders SR may be notified accordingly.
B-9 If the primary rider PR accepts a rideshare request, the ridesharing service may pick up the primary rider PR and/or the secondary rider(s) SR at their respective locations.
B-10 The primary and secondary riders PR, SR may then spend time together during the ride.
B-11 Once the ridesharing service arrives at the destination location L2, the primary rider PR may exit the vehicle, and the secondary rider SR may choose to (i) also exit the vehicle, (ii) continue to a different location, or (iii) return to his/her original location. Note that the primary rider PR is not obligated to exit the vehicle if he/she may wish to continue spending time with the secondary rider SR.
B-12 If, at B-6, no secondary riders SR send a ride request to the primary rider PR, the primary rider PR may choose (I) to ride alone, (ii) to reschedule the ride for another time, (iii) to reschedule the ride to a different destination location, (iv) to cancel the scheduled ride, or (v) to take other actions and any combination thereof.
B-13 If, at B-8, the primary rider PR does not accept any ride requests from any secondary riders SR, the primary rider PR may choose (i) to ride alone, (ii) to reschedule the ride for another time, (iii) to reschedule the ride to a different destination location, (iv) to cancel the scheduled ride, or (v) to take other actions and/or any combinations thereof.

It is understood that the summary of steps described above is meant for demonstration and that the actual process may include additional steps not listed and/or less steps than listed. It is also understood that any of the steps may be performed in any different order.

### Additional Embodiments

In some embodiments, any acts from scenario #1 and scenario #2 may be combined in any way to form any new sequences of acts that may be taken by the primary rider PR, the secondary rider(s) SR, the system 10, and the driver while utilizing the functionalities of the system 10. It is understood that any such new sequences of acts are all within the scope of the system 10.

In some embodiments, the primary rider's pickup location may be the same or different than the secondary rider's pickup location.

In some embodiments, the primary rider's destination location may be the same or different than the secondary rider's destination location.

In some embodiments, the secondary rider SR may be picked up prior to the primary rider PR pickup or after the primary rider PR pickup.

In some embodiments, the secondary rider SR may be picked up along the way to the primary rider's destination location.

In some embodiments, the secondary rider SR may be dropped off at his/her destination location prior to or after arrival at the primary rider's destination location.

In some embodiments, if two or more secondary riders SR are matched to accompany the primary rider PR as described above, the system 10 may facilitate any of the following outcomes:
1. The primary rider PR chooses which secondary rider SR out of all of the matched secondary riders SR gets to accompany him/her during the trip.
2. The system 10 chooses which secondary rider SR out of all of the matched secondary riders SR gets to accompany the primary rider PR during the trip. Based on a comparison of the personal profiles of the primary rider PR and the secondary riders SR, the system 10 may utilize matching algorithms to apply a match score for each primary rider PR—secondary rider SR pairing, and the system 10 may then choose the secondary rider SR with the highest match score to accompany the primary rider PR.
3. Each matched secondary rider SR is scheduled to accompany the primary rider PR during a distinct portion of the trip. In this way, the primary rider PR may spend time with each secondary rider SR, one at a time during different portions of the trip.
4. Each matched secondary rider SR is picked up at his/her pickup location along the way from the primary rider's pickup location to his/her destination location. In this way, multiple secondary riders SR may accompany the primary rider PR at any time.
5. Any combination thereof.

In some embodiments, the system 10 may choose a secondary rider SR to accompany the primary rider PR (e.g., based on the outcome of a matching algorithm comparing the primary rider PR and secondary rider SR personal profile information). In some embodiments of this sort, the primary rider PR and/or the secondary rider SR may accept or decline the system's choice, while in other embodiments, the primary rider PR and the secondary rider SR must accept the system's choice (this is akin to a blind date scenario).

In some embodiments, a primary rider PR and/or a secondary rider SR may edit, alter, or otherwise change his/her ride criteria at any time. For example, a secondary rider SR may be willing to extend the location radius pertaining to a ride that he/she is interested in. In this way, a ride that may otherwise not meet the secondary rider's ride criteria may be meet the criteria after the rider criteria amendment.

In some embodiments, if a secondary rider's ride request is declined by a particular primary rider PR, the ride information including the primary rider's profile information is removed from the secondary rider's view.

In some embodiments, if a primary rider's ride invitation is declined by a particular secondary rider SR, the ride information including the secondary rider's profile information is removed from the primary rider's view.

In some embodiments, the secondary rider SR is required to pay the entire fee, or at least a portion of the fee, for the primary rider's transport. This payment is facilitated by the system 10. In other embodiments, the primary rider PR and/or the secondary rider SR may be provided with a methodology through the system 10 to tip the driver. In some embodiments, payment is required prior to pickup of the secondary rider SR.

System Structure

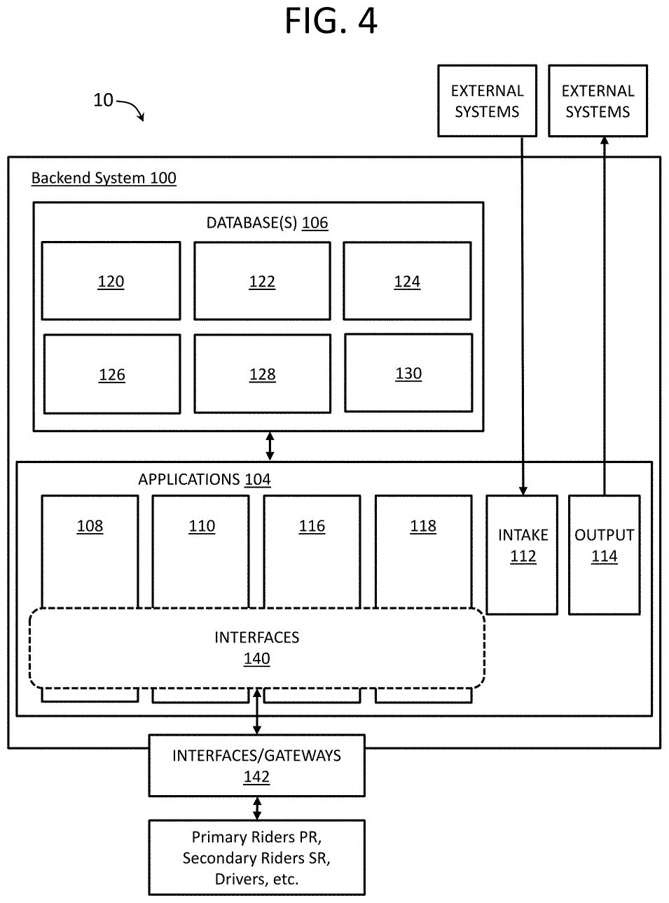

FIG. 4 shows aspects of an exemplary transportation dating system 10 of FIG. 1. As shown, the system 10 and backend system 100 comprises various internal applications 104 and one or more databases 106, described in greater detail below. The internal applications 104 may generally interact with the one or more databases 106 and the data stored therein.

The database(s) 106 may comprise one or more separate or integrated databases, at least some of which may be distributed. The database(s) 106 may be implemented in any manner, and, when made up of more than one database, the various databases need not all be implemented in the same way. It should be appreciated that the system is not limited by the nature or location of database(s) 106 or by the manner in which they are implemented.

Each of the internal applications 104 may provide one or more services via an appropriate interface. Although shown as separate applications 104 for the sake of this description, it is appreciated that some or all of the various applications 104 may be combined. The various applications 104 may be implemented in any manner and need not all be implemented in the same way (e.g., using the same software languages, interfaces, or protocols).

In some embodiments, the applications 104 may include one or more of the following applications 104:
1. Transportation system application(s) 108. This application may include any and all of the applications necessary for the transportation system 300 to perform its functionalities. This application may include ridesharing applications 302, taxi service applications 304, other transportation system services and any combination thereof.
2. Ride matching application(s) 110. This application may include any and all of the applications necessary for (i) the primary riders PR to view, and potentially send a ride invitation to, the available secondary riders SR, (ii) for the secondary riders SR to receive, and accept or decline a ride invitation, (iii) for the secondary riders SR to view, and potentially send a ride request to, the available primary riders PR, (iv) for the primary rider PR to receive, and accept or decline a ride request, (v) for any type of match to be made between a primary rider PR and a secondary rider SR, and (vi) for any other functionality required to provide the ride matching services as described herein.
3. Data input application(s) 112. This application may input any type of data from any applicable system and/or element such as the application 200, the transportation system 300, any other system and/or element and any combination thereof.
4. Data output application(s) 114. This application may output any type of data to any applicable system and/or element such as the application 200, the transportation system 300, any other system and/or element and any combination thereof.
5. Data reporting application(s) 116. This application may generate any type of report regarding the use and/or functionalities of the system 10 including completed rides, matched riders, any other types of data and/or information and any combination thereof.
6. Navigational application(s) 118. This application includes a Global Positioning System (GPS) or other types of geolocation systems to locate the position of the primary riders PR, the secondary riders SR, the transportation system drivers, pick up locations, destination locations, and any other types of locations as required by the system 10.

The applications 104 also may include other applications and/or auxiliary applications (not shown). Those of ordinary skill in the art will appreciate and understand, upon reading this description, that the above list of applications is meant for demonstration and that the system 10 may include other applications that may be necessary for the system 10 to generally perform its functionalities as described in this specification. In addition, as should be appreciated, embodiments or implementations of the system 10 need not include all of the applications listed, and that some or all of the applications may be optional. It is also understood that the scope of the system 10 is not limited in any way by the applications that it may include.

In some embodiments, the database(s) 106 may include one or more of the following databases 106:
1. User information database(s) 120. This database may store any type registration and/or profile information for any primary rider PR, secondary rider SR and/or any other type of use of the system 10.
3. Scheduled ride database(s) 122. This database may store information regarding each ride scheduled by each primary rider PR. This information may then be shared with potential secondary riders SR as described herein.
3. Available secondary rider SR database(s) 124. This database may store information regarding the secondary riders SR who are available at any given time and location for participation with the system 10.
4. Usage history database(s) 126. This database may store any type of historical data pertaining to any user of the system (e.g., primary riders PR, secondary riders SR, etc.) and any rides taken by such users. This also may include information relating to ride invitations, ride requests, matches made, and/or any other types of information.
5. Transportation system database(s) 128. This database may store any data and/or other types of information related to and/or used by the transportation system 300 as necessary for it to perform its functionalities.
6. Data report(s) database(s) 130. This database may store any reports of any kind generated by the system 10.

It is understood that the above list of databases is meant for demonstration and that the system 10 may include some or all of the databases, and also may include additional databases as required. It is also understood that the scope of the system 10 is not limited in any way by the databases that it may include.

Various applications 104 and databases 102 in the transportation dating system 10 may be accessible via interface(s) 142. These interfaces 142 may be provided in the form of APIs or the like and made accessible to external users PR, SR via one or more gateways and interfaces 144 (e.g., via a web-based application 200 and/or a mobile application 200 running on a client's personal device 400 such as a mobile phone, tablet computer, desktop computer, laptop computer, etc.).

It is understood that any aspect and/or element of any embodiment described herein or otherwise may be combined in any way to form new embodiments all of which are easily understood by a person of ordinary skill in the art and all of which are within the scope of the system 10.

Those of ordinary skill in the art will appreciate and understand, upon reading this description, that embodiments hereof may provide different and/or other advantages, and that not all embodiments or implementations need have all advantages.

Application 300

In some embodiments, the application 300 resides an electronic device 400 such as a smartphone, a tablet computer, a laptop computer, a mobile music player, other types of electronic devices and any combination thereof. The application 300 includes a graphical user interface (GUI) that may be presented on the device's display and that includes controls (e.g., touchscreen and/or mechanical buttons, etc.) that a primary rider PR and/or secondary rider SR may activate to interact with the system 10. For example, the GUI may include controls and/or other mechanisms that enable the riders PR, SR to interface with the system 10 during its general usage (e.g., to log into the system 10, request a ride, view ride requests, view available rides, view ride invitations, etc.). In one example, a rider PR, SR may swipe right to accept a ride request and/or a ride invitation, or swipe left to decline a ride request and/or a ride invitation. Other types of controls may include buttons, dials, check boxes, drop-down menus, scroll bars, other types of controls and any combination thereof.

In some embodiments, the application 300 includes voice recognition capabilities so that it may receive and implement voice commands from the riders PR, SR. In addition, the application 300 may accommodate any language.

In some embodiments, the application 300 may present instructions, wizards, and/or other types of guidance to the riders PR, SR via the GUI.

Computing

The services, mechanisms, operations, and acts shown and described above are implemented, at least in part, by software running on one or more computers or computer systems or devices. It should be appreciated that each user device is, or comprises, a computer system.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

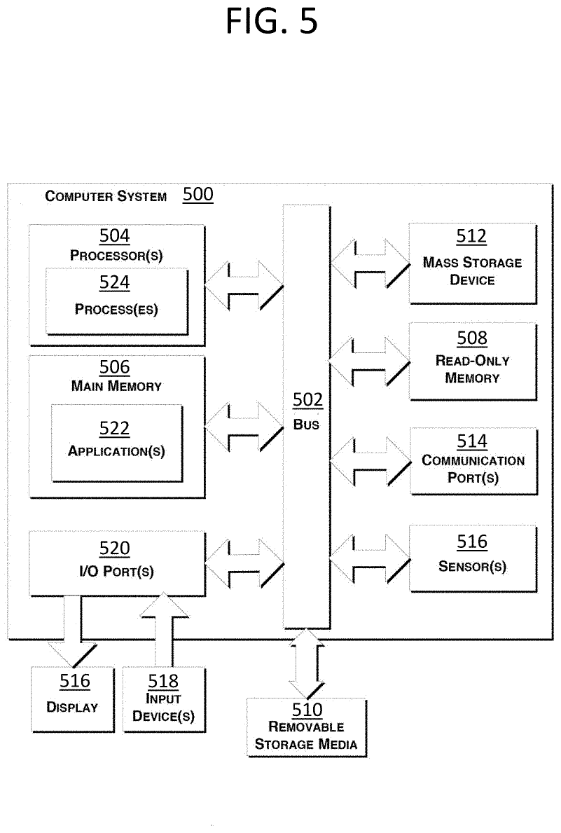

FIG. 5 is a schematic diagram of a computer system 500 upon which embodiments of the present disclosure may be implemented and carried out.

According to the present example, the computer system 500 includes a bus 502 (i.e., interconnect), one or more processors 504, one or more communications ports 514, a main memory 506, removable storage media 510, read-only memory 508, and a mass storage 512. Communication port(s) 514 may be connected to one or more networks by way of which the computer system 500 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 504 can be (or include) any known processor, such as, but not limited to, an Intel® Itanium® or Itanium 2® processor(s), AMD® Opteron® or Athlon MP® processor(s), or Motorola® lines of processors, and the like. Communications port(s) 514 can be any of an RS-232 port for use with a modem based dial-up connection, a 10/100 Ethernet port, a Gigabit port using copper or fiber, or a USB port, and the like. Communications port(s) 514 may be chosen depending on a network such as a Local Area Network (LAN), a Wide Area Network (WAN), a CDN, or any network to which the computer system 500 connects. The computer system 500 may be in communication with peripheral devices (e.g., display screen 516, input device(s) 518) via Input/Output (I/O) port 520. Some or all of the peripheral devices may be integrated into the computer system 500, and the input device(s) 518 may be integrated into the display screen 516 (e.g., in the case of a touch screen).

Main memory 506 can be Random Access Memory (RAM), or any other dynamic storage device(s) commonly known in the art. Read-only memory 508 can be any static storage device(s) such as Programmable Read-Only Memory (PROM) chips for storing static information such as instructions for processor(s) 504. Mass storage 512 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 502 communicatively couples processor(s) 504 with the other memory, storage and communications blocks. Bus 502 can be a PCI/PCI-X, SCSI, a Universal Serial Bus (USB) based system bus (or other) depending on the storage devices used, and the like. Removable storage media 510 can be any kind of external hard-drives, floppy drives, IOMEGA® Zip Drives, Compact Disc-Read Only Memory (CD-ROM), Compact Disc-Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements that are appropriate to perform the methods.

As shown, main memory 506 is encoded with application(s) 522 that support(s) the functionality as discussed herein (an application 522 may be an application that provides some or all of the functionality of one or more of the mechanisms described herein). Application(s) 522 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 504 accesses main memory 506 via the use of bus 502 in order to launch, run, execute, interpret or otherwise perform the logic instructions of the application(s) 522. Execution of application(s) 522 produces processing functionality of the service(s) or mechanism(s) related to the application(s). In other words, the process(es) 524 represents one or more portions of the application(s) 522 performing within or upon the processor(s) 504 in the computer system 500.

It should be noted that, in addition to the process(es) 524 that carries(carry) out operations as discussed herein, other embodiments herein include the application 522 itself (i.e., the un-executed or non-performing logic instructions and/or data). The application 522 may be stored on a computer readable medium (e.g., a repository) such as a disk or in an optical medium. According to other embodiments, the application 522 can also be stored in a memory type system such as in firmware, read only memory (ROM), or, as in this example, as executable code within the main memory 506 (e.g., within Random Access Memory or RAM). For example, application 522 may also be stored in removable storage media 510, read-only memory 508, and/or mass storage device 512.

Those skilled in the art will understand that the computer system 500 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of routing a vehicle in a transportation system, the method comprising:
(A) receiving, at the transportation system, a request to route the vehicle from a first location to a second location, the request generated in response to receiving a request for transport services from a first client device associated with a first user of the transportation system;
(B) receiving, at the transportation system, a notification from one or more second client devices associated with one or more second users of the transportation system indicating an availability of the one or more second users to join the first user during at least a portion of the transport services;
(C) determining, at the transportation system, one or more ride candidates from the one or more second users based on a ride candidate criteria;
(D) displaying, on the first client device, information relating to the one or more ride candidates;
(F) receiving, at the transportation system, a notification from the first client device information from the first user indicating a choice of one of the one or more ride candidates;
(G) sending, from the transportation system, an invitation to the second client device associated with the chosen one of the one or more ride candidates to join the first user during the transport services;
(H) in response to an acceptance of the invitation received from the second client device associated with the chosen one of the one or more ride candidates, determining, by a processor of the transportation system, a route for the vehicle from the first location to the location of the second client device associated with the chosen one of the one or more ride candidates to the second location; and
(I) transmitting data relating to the route to the vehicle.

2. The method of claim 1 wherein the transport services includes transportation from the first location to the second location.

3. The method of claim 1 wherein the at least a portion of the transport services includes transportation along at least one segment between the first location and the second location.

4. The method of claim 1 wherein the ride candidate criteria is based at least in part on the location of the secondary rider.

5. The method of claim 1 wherein the ride candidate criteria is based at least in part on the gender and/or sexual preference of the secondary rider.

6. The method of claim 1 wherein the ride candidate criteria is based at least in part on the date and time of the request for transport services.

7. The method of claim 1 wherein the determining one or more candidates in (D) comprises:

8. The method of claim 1 wherein the determination made in (D) includes determining the distance between the location of the one or more second client devices associated with the one or more second users and the first location, and comparing the determined distance to a first distance threshold value.

9. The method of claim 1 wherein the determination made in (D) includes determining the distance between the location of the one or more second client devices associated with the one or more second users and the second location, and comparing the determined distance to a second distance threshold value.

10. The method of claim 1 wherein the information relating to the one or more candidates displayed in (E) includes a picture of each of the one or more candidates.

11. The method of claim 1 wherein the information relating to the one or more candidates displayed in (E) includes the age of each of the one or more candidates.
